(19) United States
(12) Patent Application Publication
(10) Pub. No.: US 2025/0392564 A1
(43) Pub. Date: Dec. 25, 2025

(54) ORGANIZING DISTRIBUTION OF DNS INFORMATION IN A COMPUTER NETWORK

(71) Applicant: International Business Machines Corporation, Armonk, NY (US)

(72) Inventors: Daniel Pittner, Esslingen am Neckar (DE); Norman Christopher Böwing, Boblingen (DE); Cale Thomas RATH, Byron, MN (US)

(21) Appl. No.: 18/783,901

(22) Filed: Jul. 25, 2024

(30) Foreign Application Priority Data
Jun. 24, 2024 (GB) 2409000.3

(51) Int. Cl. H04L 61/4511

(52) U.S. Cl. CPC H04L 61/4511

(57) ABSTRACT

A method of organizing distribution of information related to a domain name system, DNS, in a computer network is provided. The method includes, by a first node of the computer network: performing a container-based execution of a first instance of a software application, thereby aggregating DNS information specific to the software application; generating a DNS message indicative of the DNS information; and transmitting the DNS message to a second node of the computer network for usage of the DNS information by a container-based execution of a second instance of the software application.

### BACKGROUND

The present disclosure relates to organizing distribution of information related to a domain name system (DNS) in a computer network.

Serverless application and run-to-completion workload running in a computing cluster may face latency when performing DNS lookups. Execution scenarios for these types of workload may follow a paradigm of operating system-(OS-) level virtualization in which the kernel allows the existence of multiple isolated user space instances, called containers (e.g., using Linux (LXC), Solaris, Docker, Podman), zones (for Solaris containers), virtual private servers (using OpenVZ), partitions (e.g., AIX workload partitions (WPAR), HP-UX Secure Resource Partitions (SRP)), virtual environments (VEs), virtual kernels (using DragonFly BSD), or jails (e.g., FreeBSD jail or chroot jail).

Serverless workload may be invoked frequently in typical scenarios. Containers may start up with an empty DNS cache, such that all DNS lookups must be performed on each start of a software application, thus causing a latency. This is undesirable as latency often is a critical element for serverless workloads.

For run-to-completion workload a single job may consist of multiple (e.g., hundreds or thousands of) job run invocations, all performing a single part of the overall job. With this usage pattern all invocations of an instance of a software application may be running in their own containers, starting with an empty DNS cache leading to multiple redundant DNS lookups and latency.

In order to make a workload highly available, work may be distributed among worker nodes, and standard caching mechanisms like a node-local cache may fail, e.g., on a first invocation of an application on that worker node. Moreover, executing the same job in a highly concurrent way from many machines may yield redundant DNS lookups for the same records, resembling a distributed denial of service (DDOS) attack on the DNS server.

Prior art US 2010/0 257 258 A1 discloses a distributed DNS network including a central origin server that actually controls the zone, and edge DNS cache servers configured to cache the DNS content of the origin server. The edge DNS cache servers are published as the authoritative servers for customer domains instead of the origin server. When a request for a DNS record results in a cache miss, the edge DNS cache servers get the information from the origin server and cache it for use in response to future requests.

### SUMMARY

In one aspect, the present disclosure relates to a method of organizing distribution of information related to a domain name system, DNS, in a computer network, the method comprising, by a first node of the computer network: performing a container-based execution of a first instance of a software application, thereby aggregating DNS information specific to the software application; generating a DNS message indicative of the DNS information; and
transmitting the DNS message to a second node of the computer network for usage of the DNS information by a container-based execution of a second instance of the software application.

As will be explained below in further detail, the method may provide for a significant decrease of latency for the container-executed application instances and/or a decrease of load on DNS infrastructure for container-based workload deployment schemes such as serverless and run-to-completion workload. This may result in a more fail-safe operation of the DNS servers, and thus, an improved fault tolerance of the computer network and an improved stability of the computing environment as a whole. Moreover, by removing DNS as a bottleneck of the distributed container-executed software instances, the environment may be scaled much further, or respectively, with a lower requirement of resources for the DNS infrastructure.

In an example, the method further comprises, by the second node, transmitting a request for a container-based execution of the second instance to a third node of the computer network, the request being configured to cause the third node to perform the container-based execution of the second instance using the DNS information. As will be explained below in further detail, this may enable a centralized management of the DNS information by the second node (e.g., an orchestrator node).

In an example, the method further comprises, by the second node, performing the container-based execution of the second instance using the DNS information. As will be explained below in further detail, this may enable a distribution of the DNS information between the first and the second node without causing additional overhead network traffic and/or resource consumption for an orchestrator node distributing container-based jobs to the first and second nodes.

In a further aspect, the present disclosure relates to a method of organizing distribution of information related to a domain name system, DNS, in a computer network, the computer network comprising worker nodes and an orchestrator node, the orchestrator node being configured for distributing workload via the computer network for container-based execution by the worker nodes, the method comprising, by the orchestrator node: receiving a DNS message from a first one of the worker nodes, the DNS message being indicative of DNS information aggregated by a container-based execution of a first instance of a software application by the first worker node; and transmitting a request for a container-based execution of a second instance of the software application to a second one of the worker nodes, the request being configured to cause the second worker node to perform a container-based execution of a second instance of the software application using the DNS information.

In a further aspect, the present disclosure relates to a method of organizing distribution of information related to a domain name system, DNS, in a computer network, the computer network comprising worker nodes and an orchestrator node, each worker node being configured for container-based execution of workload distributed by the orchestrator node via the computer network, the method comprising, by a second one of the worker nodes:
receiving DNS information from a first one of the worker nodes, the DNS information being aggregated by a container-based execution of a first instance of a software application by the first worker node; and
performing a container-based execution of a second instance of the software application using the DNS information.

In a further aspect, the present disclosure relates to a computer program product for organizing distribution of information related to a domain name system, DNS, in a computer network, the computer program product comprising a computer readable storage medium having program instructions embodied therewith, the program instructions being executable by a first node of the computer network to cause the first node to perform a method comprising:
performing a container-based execution of a first instance of a software application, thereby aggregating DNS information specific to the software application;
generating a DNS message indicative of the DNS information; and
transmitting the DNS message to a second node of the computer network for usage of the DNS information by a container-based execution of a second instance of the software application.

In a further aspect, the present disclosure relates to a computer program product for organizing distribution of information related to a domain name system, DNS, in a computer network, the computer network comprising worker nodes and an orchestrator node, the orchestrator node being configured for distributing workload via the computer network for container-based execution by the worker nodes, the computer program product comprising a computer readable storage medium having program instructions embodied therewith, the program instructions being executable by the orchestrator node to cause the orchestrator node to perform a method comprising:
receiving a DNS message from a first one of the worker nodes, the DNS message being indicative of DNS information aggregated by a container-based execution of a first instance of a software application by the first worker node; and
transmitting a request for a container-based execution of a second instance of the software application to a second one of the worker nodes, the request being configured to cause the second worker node to perform a container-based execution of a second instance of the software application using the DNS information.

In a further aspect, the present disclosure relates to a computer program product for organizing distribution of information related to a domain name system, DNS, in a computer network, the computer network comprising worker nodes and an orchestrator node, each worker node being configured for container-based execution of workload distributed by the orchestrator node via the computer network, the computer program product comprising a computer readable storage medium having program instructions embodied therewith, the program instructions being executable by a second one of the worker nodes to cause the second worker node to perform a method comprising:
receiving DNS information from a first one of the worker nodes, the DNS information being aggregated by a container-based execution of a first instance of a software application by the first worker node; and
performing a container-based execution of a second instance of the software application using the DNS information.

In a further aspect, the present disclosure relates to a computing device being configured as a first node of a computer network, the computing device comprising a processor and a memory, the memory storing program instructions which, when executed by the processor, cause the computing device to perform a method of organizing distribution of information related to a domain name system, DNS, in the computer network, the method comprising:
performing a container-based execution of a first instance of a software application, thereby aggregating DNS information specific to the software application;
generating a DNS message indicative of the DNS information; and
transmitting the DNS message to a second node of the computer network for usage of the DNS information by a container-based execution of a second instance of the software application.

In a further aspect, the present disclosure relates to a computing device being configured as an orchestrator node of a computer network, the computer network further comprising worker nodes, the orchestrator node being configured for distributing workload via the computer network for container-based execution by the worker nodes, the computing device comprising a processor and a memory, the memory storing program instructions which, when executed by the processor, cause the computing device to perform a method of organizing distribution of information related to a domain name system, DNS, in the computer network, the method comprising:
receiving a DNS message from a first one of the worker nodes, the DNS message being indicative of DNS information aggregated by a container-based execution of a first instance of a software application by the first worker node; and
transmitting a request for a container-based execution of a second instance of the software application to a second one of the worker nodes, the request being configured to cause the second worker node to perform a container-based execution of a second instance of the software application using the DNS information.

In a further aspect, the present disclosure relates to a computing device being configured as a second worker node of a computer network, the computer network further comprising a first worker node and an orchestrator node, each worker node being configured for container-based execution of workload distributed by the orchestrator node via the computer network, the computing device comprising a processor and a memory, the memory storing program instructions which, when executed by the processor, cause the computing device to perform a method of organizing distribution of information related to a domain name system, DNS, in the computer network, the method comprising:
receiving DNS information from the first worker node, the DNS information being aggregated by a container-based execution of a first instance of a software application by the first worker node; and
performing a container-based execution of a second instance of the software application using the DNS information.

Embodiments of the present disclosure are given in the dependent claims. Embodiments of the present disclosure can be freely combined with each other if they are not mutually exclusive.

### BRIEF DESCRIPTION OF THE DRAWINGS

In the following, embodiments of the present disclosure are explained in greater detail, by way of example only, making reference to the drawings in which:

FIG. 1 is a block diagram depicting components of computing devices in a network context, according to embodiments;

FIG. 2 is a block diagram illustrating a transmission of a DNS message related to a container-based execution of a first instance of a software application by a first node of a computer network, according to embodiments;

FIG. 3 is a block diagram illustrating distribution of DNS information related to a container-based execution of a second instance of a software application by a third node of a computer network, according to embodiments; and

FIG. 4 is a block diagram illustrating a transfer of DNS information between two worker nodes of a computer network, according to embodiments.

### DETAILED DESCRIPTION

The presence of information related to a domain name system (DNS) may influence latency for container-based workloads. Container-based execution of a software application may include that each instance of the application is executed in a new container. New containers may be initialized with an empty DNS cache. Thus, latency due to DNS lookups may occur on each start of a container-based application instance. Moreover, workload for container-based execution may be distributed over a computer network to enable concurrent processing of the workload by different nodes of the network. Each node participating in distributed processing of a workload may have its own local DNS cache that is accessible to all containers running on that node. DNS queries causing a cache miss in a local DNS cache may be forwarded via the network to a DNS server. Therefore, multiple concurrent startups of instances of the same application may cause redundant DNS queries for a DNS server. This may contribute further to latency experienced by the distributed instances. In view thereof, improved approaches of organizing distribution of DNS-related information in a computer network are desirable.

Methods described herein may be implemented by different nodes of a computer network. It is assumed presently that a computer network (herein also referred to as a network) suitably configured for implementing one or more of the methods described herein may comprise multiple worker nodes and at least one orchestrator node. An orchestrator node may receive (locally or via the network) workload instructions for executing workload involving one or more software applications (herein also referred to as applications or apps) to be executed within containers running on one or more of the worker nodes. The orchestrator node (e.g., a Kubernetes API server or similar) may have access to resource information about current capabilities of each worker node, regarding, e.g., resources or applications available on the respective worker node. Based on the resource information, the orchestrator node may select one or more of the worker nodes for performing a container-based execution of an instance of an application specified by the workload instructions, and transmit corresponding job requests to the selected worker nodes, causing each selected worker node to perform a container-based execution of the application instances specified by the respective job request. Within the set of nodes available in the network, a given orchestrator node, the subset of nodes that are available as worker nodes to that orchestrator node, and the connections between these nodes provided by the computer network may together be referred to as a cluster. One or more nodes of the network may operate a DNS server configured to reply to DNS requests issued by software running on any node of the network.

One of the methods described herein may be performed by a first node of the computer network. The method includes performing a container-based execution of a first instance of a software application by the first node. The first node may be a worker node configured to perform contained-based executions of software application instances in response to receiving corresponding instructions from an orchestrator node.

A worker node may operate a repository of DNS-related information that is locally accessible to software running on the worker node and is referred to as a DNS cache, independent of hardware specifications characterizing memory storing such repository. The DNS cache may store responses by DNS servers to DNS queries issued by applications running or available on the respective worker node. Additions, deletions, or alterations of information stored by the DNS cache may be caused, e.g., by DNS-related functions of applications currently executed by the worker node, and cache management processes operated by, e.g., an operating system (OS) running on the worker node. Information stored by the DNS cache for a particular application is referred to herein as DNS information specific to that software application. Non-limiting implementation examples of a node-local cache process include a Kubernetes node-local cache or an extended Berkeley Packet Filter-(eBPF-) based solution to intercept network traffic.

Accordingly, said container-based execution of a first instance of a software application by a first node may yield an aggregation of DNS information for that application in a first DNS cache operated by the first node. In particular, the first instance may have to perform DNS lookups using the first DNS cache, and for those DNS lookups returning a cache miss of the first DNS cache, the first node may forward the corresponding DNS query to a DNS server, receive a DNS lookup response from the DNS server, and store the response in the first DNS cache, adding the response to any further DNS information the first DNS cache might store for the software application.

The method further comprises generating a DNS message indicative of the DNS information by the first node. For instance, the DNS message may include the DNS information currently available in the first DNS cache, or a portion thereof. In another example, the DNS message may be descriptive of the DNS information, including, e.g., an assignment of an identifier of the first node to an identifier of the software application, thus yielding the context that DNS information related to that software application is available at the first node.

The DNS message is transmitted to a second node of the computer network. Depending on implementation and context, the second node may be another worker node (thus implementing the method of organizing distribution of DNS-related information by a second worker node described herein) or an orchestrator node assigned to the first node (thus implementing method of organizing distribution of DNS-related information by an orchestrator node described herein). The transmission of the DNS message may be triggered in an implementation-specific manner, e.g., when the container-based execution of the first instance is finished, when the DNS query result or at least a threshold number of DNS query results is received by the first node, or at predefined time intervals. The DNS message, or characteristics of the transmission process, may be configured to cause a node executing another instance of the application (e.g., the second node or a third node of the computer network) to use the DNS information that was aggregated by the first node. For this purpose, the DNS message, or said characteristics of the transmission process, may cause the executing node to receive the DNS information from the first node, e.g., by direct transport of the DNS information using the DNS message or a job request containing the DNS information, or indirectly by causing the executing node to retrieve the DNS information from the first node.

According to the method performed by the first node, DNS information that is locally aggregated by and available at the first node may, by virtue of transmission of the DNS message to a second node, enable and cause a usage of the DNS information during a container-based execution of another instance of the software application on another node of the computer network. Using the DNS information from the first node, the node executing the second instance may get a larger number of cache hits from the local DNS cache of the executing node, thus reducing the latency for the second instance and the number of DNS queries to be handled by the DNS server as well. Hence, embodiments of the present disclosure may have the advantage of significantly decreasing latency for the container-executed application instances and/or decreasing the load on DNS infrastructure for container-based workload deployment schemes such as serverless and run-to-completion workload.

Concerning the computing environment (e.g., the computer network or the cluster) as a whole, a load reduction for the DNS infrastructure may yield a lower overload probability. This may result in a more fail-safe operation of the DNS servers, and thus, an improved fault tolerance of the computer network and an improved stability of the computing environment as a whole. Moreover, by removing DNS as a bottleneck of the distributed container-executed software instances, the environment may be scaled much further, or respectively, with a lower requirement of resources for the DNS infrastructure.

In an example, the method further comprises, by the second node, transmitting a request for a container-based execution of the second instance to a third node of the computer network, the request being configured to cause the third node to perform the container-based execution of the second instance using the DNS information. This may enable a centralized management of the DNS information by the second node (e.g., an orchestrator node), which may, e.g., store any DNS information received from worker nodes in an assignment to the respective applications, and may contribute to a more homogeneous distribution of DNS information among the worker nodes. In particular, the third node (e.g., a worker node) may be configured to fill its local second DNS cache with the DNS information prior to performing the container-based execution of the second instance.

In an example, the method further comprises, by the third node, retrieving the DNS information from the first node. This decentralized retrieval of DNS information may reduce network traffic for the orchestrator node (the second node) and may further reduce processing load for the orchestrator node. For instance, the third node may receive a request from the second node for performing a container-based execution of a second instance of the software application, wherein the request may contain an indication that DNS information for the requested application is available for retrieval from the first node. The third node may use this indication to request the DNS information specific to the requested application from the first node. Upon receipt of the DNS information from the first node, the third node may store the received DNS information in its local DNS cache. Preferably, the third node may be configured to complete storing the DNS information specific to the software application received from the first node before starting the requested container-based execution of the second instance of the software application. DNS queries by the second instance may then have a higher likelihood to get completed by a cache hit, reducing the number of DNS requests to be forwarded to the DNS server and reducing DNS-caused latency experienced by the second instance.

In an example, the transmission of the DNS message is performed only if the first instance is part of a serverless workload. For serverless workload, different instances of the same application may be invoked frequently, but may be part of different workload instructions processed by the second node (e.g., an orchestrator node) and may be handed over to different worker nodes for container-based execution. Serverless workload may use pre-warmed containers that may be initialized with DNS information that was aggregated locally by earlier instances of the software application, but it may be infeasible, or inefficient at least, to clone pre-warmed containers between worker nodes. Transmitting the DNS message for serverless workloads may circumvent this limitation, enabling a more effective container pre-warming on different nodes. Limiting the transmission of the DNS message to the second node (e.g., an orchestrator node) to application instances that are part of a serverless workload may thus increase efficiency of resource requirements of the worker nodes for performing container-based workload processing, but without causing additional overhead for the second and third node for other types of container-based workload that may occur less frequently or less regularly, and may enable benefits of decentralized distribution of DNS information, as explained herein, for other types of container-based workload.

In an example, the method further comprises, by the second node, storing the DNS information in a dataset of the software application within an application definition database. This may enable a preservation of the DNS information that was collected during processing of a given workload instruction by the second node (e.g., an orchestrator node) for subsequent workload instructions to be processed by the second node that are unrelated to the given workload instruction and/or occur after an expiry time of workload-specific information on the second node. Therefore, DNS-related efficiency of the cluster may increase over time. For instance, the second node may operate a database of software applications that are available on the worker nodes. The second node may then store the DNS information received from the worker nodes specific to a given application within the database entry for that application, and read out the DNS information from the application database and provide the read DNS information to the respective worker nodes (e.g., the third node) when a container-based instance of the given application is to be executed. Storage of DNS information may include maintenance routines such as deduplication to reduce memory consumption of the DNS information.

In an example, the method further comprises, by the second node, performing the container-based execution of the second instance using the DNS information. Here, the first node may be a worker node and the second node may be another worker node. This may enable a distribution of the DNS information between worker nodes without causing additional overhead network traffic and/or resource consumption for an orchestrator node distributing container-based jobs to the first and second nodes. For instance, the first node may include the DNS information in the DNS message to transfer the DNS information to the second node directly. Alternatively, the first node may use the DNS message to indicate to the second node that DNS information for the software application is available for retrieval from the first node, such that the second node may request and receive the DNS information from the first node when needed (e.g., when initializing container-based execution of the second instance of the software application).

In an example, the transmission of the DNS message is performed only if the first instance is part of a run-to-completion workload. Run-to-completion workload may include a concurrent startup and execution of many (e.g., hundreds of) instances of the same application on different worker nodes. The concurrent nature of run-to-completion workload may lead to a large number of DNS queries arriving at a DNS server at nearly the same time, resembling a distributed denial of service (DDOS) attack. The distribution of DNS information using a DNS message as described herein may thus increase stability of operation for DNS servers operating in the computer network. However, directing the DNS messages to orchestrator nodes as described herein may merely shift the risk of operational failure from the DNS servers to the workload orchestrators. Hence, limiting decentralized distribution of DNS information by DNS messaging between worker nodes to run-to-completion workloads may increase operational stability of the cluster, while enabling benefits of orchestrator-based distribution of DNS information, as explained herein, for other types of container-based workload.

In an example, the first node is configured for performing the aggregation of the DNS information using a first DNS cache local to the first node, the method further comprising, by the first node, initializing the container-based execution of the first instance, the initialization comprising:
requesting a recent version of the DNS information via the computer network if the first DNS cache fulfils a cold-cache criterion with respect to the software application; and
in response to receiving the recent version, filling the first DNS cache with the recent version prior to starting the container-based execution of the first instance.

Actively requesting up-to-date DNS information for a specific app may increase DNS cache efficiency for the first node and may thus contribute further to a reduction of DNS-related latency and/or a load reduction for DNS servers in the computer network. The request for a recent version of the DNS information may be sent to one or more orchestrator nodes and/or one or more worker nodes. Nodes replying to the first node may then each return a node-specific portion of DNS information specific to the software application. If the first nodes receives multiple replies, the first DNS cache may get filled with a more diverse selection of DNS query results, enabling a more effective cache performance. Limiting the requesting of recent DNS information to cases when the first DNS cache fulfils a cold-cache criterion may decrease load for the network and/or other nodes for handling the first node's request. A cold-cache criterion may include cases when the first DNS cache is empty with respect to the software application, and/or when a portion of DNS information specific to the software application stored in the first cache is outdated by exceeding a predefined period.

In an example, the container-based execution of the second instance is performed by a worker node of the computer network, the method further comprising, by the worker node, filling a second DNS cache local to the worker node with the DNS information, the usage of the DNS information by the container-based execution of the second instance comprising reading the DNS information from the second DNS cache, the worker node being configured for delaying the filling of the second DNS cache until the worker node starts a container-based execution of an instance of the software application. This may decrease the size and/or the number of entries in the second DNS cache for a period of time when the DNS information from the first node has arrived at the worker node (which may be the second or third node depending on the implementation) but is not needed yet because no instance of the software application is running on the worker node. This in turn may increase speed and/or efficiency of the second DNS cache. In particular, the received DNS information may be stored in the second DNS cache without delay if an instance of the software application (e.g., an earlier invocation of the application than the second instance) is already running when the DNS information arrives at the worker node.

In an example, the method further comprises, by the first node in response to completing the execution of the first instance, deleting the DNS information if no further instance of the software application is scheduled for container-based execution by the first node. This may decrease the size and/or the number of entries in the first DNS cache for a period of time when the DNS information specific to the software application is not needed because no further instance of the software application is running or scheduled for execution on the first node.

In an example, the first node and the second node is registered with a common multicast group of nodes of the computer network participating in performing container-based execution of instances of the software application, the transmission of the DNS message being a multicast of the DNS message to the multicast group. This may reduce network load for nodes not participating in container-based execution of instances of the software application. In addition, multicasting the DNS message may be more secure than, e.g., a broadcast of the DNS message and may not require changes to existing protocols and/or package formats to specify which broadcast contains or is indicative of DNS information for which app. The multicast group may be set up by an orchestrator node when dispatching processing jobs among the worker nodes. Alternatively or additionally, a worker node becoming available for container-based execution of instances of a specific app may register with a corresponding existing multicast group. Another alternative to multicasting may be a shared storage collecting the DNS information from a group of authorized worker nodes, but this may have a less advantageous scaling behaviour in comparison to a multicast group.

In an example, the DNS message indicates that the first node is available for retrieval of DNS information specific to the software application. Indicating availability of DNS information may render a direct transmission of the DNS information unnecessary and may therefore reduce network traffic associated with the DNS message. This may be especially beneficial for highly concurrent workloads by temporally distributing transfers of DNS information to times when they are actually needed, thus reducing the risk of peak network loads due to simultaneous transmission of a large number if DNS messages. For instance, the DNS message may consist of pure metadata such as an address or identifier of the first node associated with an identifier of the software application, indicating (e.g., using a reserved keyword or instruction) that the first node has recent DNS query results available. An orchestrator node receiving the DNS message may include the DNS metadata in an execution request to cause a third (worker) node to fetch the DNS query results from the first node. Likewise, a worker node receiving the DNS message from the first node may store the metadata until a new container-based execution of an instance of the software application is initialized, and may then use the metadata to retrieve the DNS information from the first node. This may enable to bypass an orchestrator node for the transfer of the DNS information and may thus also contribute to a lower network traffic and/or processing load for the orchestrator node.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fibre optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 implementing the method of organizing distribution of information related to a domain name system, DNS, in a computer network described herein. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

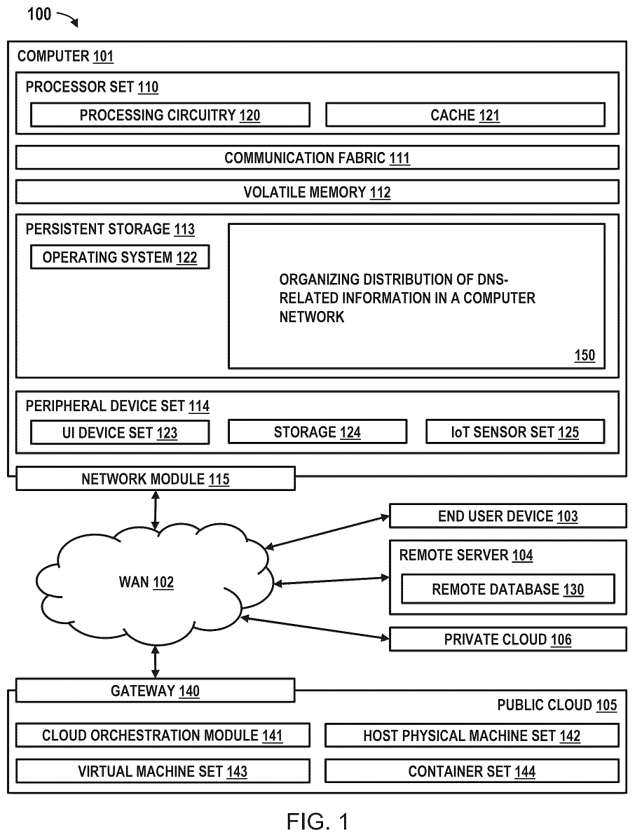

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fibre optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

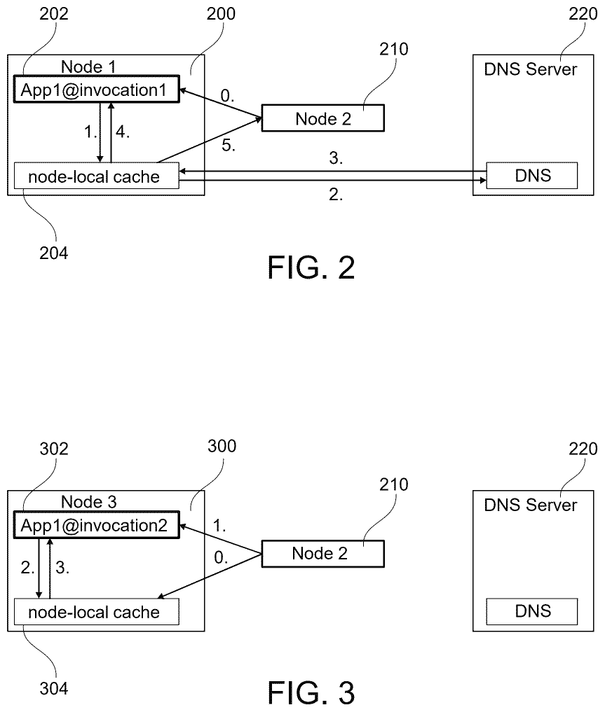

Now turning to FIG. 2, a block diagram is shown illustrating a transmission of a DNS message related to a container-based execution of a first instance of a software application by a first node of a computer network 102. Exemplary implementations of the computer network may include a wide-area network 102, a public cloud 105, a private cloud 106, or a combination thereof. The drawings generally display nodes of a computer network without showing the network connections interconnecting the nodes. Exemplary implementations of each node may include a computer 101, a remote server 104, a cloud orchestration module 141, a machine within a host physical machine set 142, a virtual machine within a virtual machine set 143. Containers enabling container-based execution of instances of software applications may be part of a container set 144.

A first node 200 of the computer network may be a worker node configured to receive (arrow 0 in the drawing) a job request for container-based execution of an instance of a software application from a second node 210 (e.g., an orchestrator node), and in response thereto, perform a container-based execution of a first instance 202 of the requested software application. The first instance 202 may be configured for using the computer network to fulfil its specific functions based upon an exchange of information with other nodes of the network. In order to resolve network addresses of the other nodes, the first instance 202 may issue a DNS query. The DNS query may be directed to a local first DNS cache 204 of the first node 200 (arrow 1).

If the DNS query results in a cache miss of the first DNS cache 204, the DNS query may be forwarded via the network to a DNS server 220 (arrow 2). The DNS server 220 may return a DNS query result to the first node 200 (arrow 3). The received DNS query result may be stored in the first DNS cache 204 and returned to the first instance 202 (arrow 4). The stored DNS query result may be added to a dataset of DNS information that is specific to the software application and may reside in the first DNS cache 204 at least while the container-based execution of the first instance 202 is continued.

The first node 200 may further be configured to generate a DNS message based on the DNS information stored in the first DNS cache 204. For instance, the DNS message may include at least a portion of the DNS information, or may include an indication that the DNS information is available at the first node 200 and is specific to the software application. The first node may transmit the DNS message to the second node 210 (arrow 5). The DNS message, or characteristics of the transmission process, may be configured to cause another worker node executing a second instance of the software application to use the DNS information that was aggregated in the first DNS cache of the first node 200 to obtain DNS query results from the second instance locally at the other worker node. The transmission of the DNS message may be triggered in an implementation-specific manner, e.g., when the container-based execution of the first instance 202 is finished, when the DNS query result or at least a threshold number of DNS query results is received by the first node 200, or at predefined time intervals.

FIG. 3 is a block diagram illustrating distribution of DNS information related to a container-based execution of a second instance 302 of the software application by a third node 300 of the computer network after the transfer of a DNS message from the first node 200 to the second node 210 indicated by arrow 5 of FIG. 2. The third node 300 may be a worker node configured to operate a local second DNS cache 304 and receive (arrow 1) a job request for container-based execution of an instance of the software application from the second node 210 (e.g., an orchestrator node). The job request may be configured for causing the third node 300 to fill the second DNS cache 304 with the DNS information specific to the software application that was aggregated in the first DNS cache 204 during the container-based execution of the first instance 202 of the software application on the first node 200 (arrow 0). For this purpose, the job request may contain an explicit copy of the DNS information, or may include an indication that the DNS information is available at the first node 200 and is specific to the software application, allowing the third node 300 to retrieve the DNS information from the first node 200.

In response to the job request, the third node 300 may perform a container-based execution of a second instance 302 of the software application. Like the first instance 202, the third instance 302 may also be configured for using the computer network to fulfil its specific functions based upon an exchange of information with other nodes of the network. In order to resolve network addresses of the other nodes, the second instance 202 may issue a DNS query. The DNS query may be directed to the second DNS cache 304 local to the second node 200 (arrow 2). If the DNS query (e.g., requesting the same DNS query result as the one the first node 200 obtained from the DNS server 220 in response to the query illustrated by arrows 1 and 2 of FIG. 2) results in a cache hit of the second DNS cache 304, the second DNS cache 304 transmits a DNS query result to the second instance 302 without having to forward the DNS query of the second instance 302 to the DNS server 220.

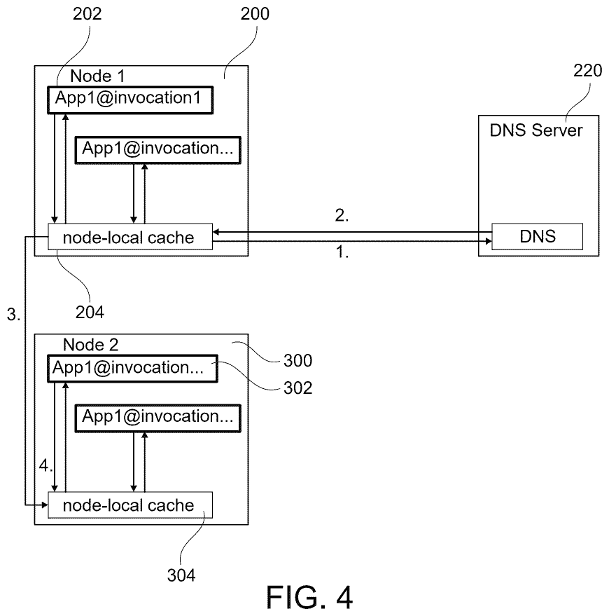

FIG. 4 is a block diagram illustrating a transfer of DNS information between two worker nodes of the computer network. This time, the first node 200 may be a first worker node and the second node 300 may be a second worker node. Each of the worker nodes 200, 300 may be configured to receive a respective request for container-based execution of an instance of a software application from an orchestrator node (not shown), and in response thereto, perform container-based executions of respective instances 202, 302 of the requested software application. Each of the worker nodes may further operate node-local DNS caches 204, 304.

A first instance 202 running within a container hosted by the first node 200 may be configured for using the computer network to fulfil its specific functions based upon an exchange of information with other nodes of the network. In order to resolve network addresses of the other nodes, the first instance 202 may issue a DNS query. The DNS query may be directed to a local first DNS cache 204 of the first node 200. If the DNS query results in a cache miss of the first DNS cache 204, the DNS query may be forwarded via the network to a DNS server 220 (arrow 1). The DNS server 220 may return a DNS query result to the first node 200 (arrow 2). The received DNS query result may be stored in the first DNS cache 204 and returned to the first instance 202. The stored DNS query result may be added to a dataset of DNS information that is specific to the software application and may reside in the first DNS cache 204 at least while the first node continues to execute at least one instance of the software application.

The first node 200 may further be configured to generate a DNS message based on the DNS information stored in the first DNS cache 204. For instance, the DNS message may include at least a portion of the DNS information, or may include an indication that the DNS information is available at the first node 200 and is specific to the software application. The first node may transmit the DNS message to the second node 210 (arrow 3). The transmission of the DNS message may be triggered in an implementation-specific manner, e.g., when the container-based execution of the first instance 202 is finished, when the DNS query result or at least a threshold number of DNS query results is received by the first node 200, or at predefined time intervals. The DNS message, or characteristics of the transmission process, may be configured to cause the second node 300 to store the DNS information that was aggregated in the first DNS cache 204 operated by the first node 200 in the second DNS cache 304. For this purpose, the second node 300 may receive the DNS information, e.g., as an embedded part of the DNS message, or may retrieve the DNS information from the first node 200 using the indication that the DNS information is available at the first node 200. As the received DNS information is stored in the second DNS cache, the second instance 302 may direct a DNS query to the second DNS cache 304 (arrow 4). If the DNS query (e.g., requesting the same DNS query result as the one the first node 200 obtained from the DNS server 220 in response to the query illustrated by arrows 1 and 2) results in a cache hit of the second DNS cache 304, the second DNS cache 304 transmits a DNS query result to the second instance 302 without having to forward the DNS query of the second instance 302 to the DNS server 220.

In the following, examples illustrating notions of the present disclosure will be described again by a list of clauses highlighting several possible, non-exclusive combinations of features disclosed herein:
1. A method of organizing distribution of information related to a domain name system, DNS, in a computer network, the method comprising, by a first node of the computer network:
   performing a container-based execution of a first instance of a software application, thereby aggregating DNS information specific to the software application;
   generating a DNS message indicative of the DNS information; and
   transmitting the DNS message to a second node of the computer network for usage of the DNS information by a container-based execution of a second instance of the software application.
2. The method of clause 1, further comprising, by the second node, transmitting a request for a container-based execution of the second instance to a third node of the computer network, the request being configured to cause the third node to perform the container-based execution of the second instance using the DNS information.
3. The method of clause 2, further comprising, by the third node, retrieving the DNS information from the first node.
4. The method of clause 2 or 3, the transmission of the DNS message being performed only if the first instance is part of a serverless workload.
5. The method of any of clauses 2 to 4, further comprising, by the second node, storing the DNS information in a dataset of the software application within an application definition database.
6. The method of clause 1, further comprising, by the second node, performing the container-based execution of the second instance using the DNS information.
7. The method of clause 6, the transmission of the DNS message being performed only if the first instance is part of a run-to-completion workload.
8. The method of any of the preceding clauses, the first node being configured for performing the aggregation of the DNS information using a first DNS cache local to the first node, the method further comprising, by the first node, initializing the container-based execution of the first instance, the initialization comprising:
   requesting a recent version of the DNS information via the computer network if the first DNS cache fulfils a cold-cache criterion with respect to the software application; and
   in response to receiving the recent version, filling the first DNS cache with the recent version prior to starting the container-based execution of the first instance.
9. The method of any of the preceding clauses, the container-based execution of the second instance being performed by a worker node of the computer network, the method further comprising, by the worker node, filling a second DNS cache local to the worker node with the DNS information, the usage of the DNS information by the container-based execution of the second instance comprising reading the DNS information from the second DNS cache, the worker node being configured for delaying the filling of the second DNS cache until the worker node starts a container-based execution of an instance of the software application.
10. The method of any of the preceding clauses, further comprising, by the first node in response to completing the execution of the first instance, deleting the DNS information if no further instance of the software application is scheduled for container-based execution by the first node.
11. The method of any of the preceding clauses, the first node and the second node being registered with a common multicast group of nodes of the computer network participating in performing container-based execution of instances of the software application, the transmission of the DNS message being a multicast of the DNS message to the multicast group.
12. The method of any of the preceding clauses, the DNS message indicating that the first node is available for retrieval of DNS information specific to the software application.
13. A method of organizing distribution of information related to a domain name system, DNS, in a computer network, the computer network comprising worker nodes and an orchestrator node, the orchestrator node being configured for distributing workload via the computer network for container-based execution by the worker nodes, the method comprising, by the orchestrator node:
   receiving a DNS message from a first one of the worker nodes, the DNS message being indicative of DNS information aggregated by a container-based execution of a first instance of a software application by the first worker node; and
   transmitting a request for a container-based execution of a second instance of the software application to a second one of the worker nodes, the request being configured to cause the second worker node to perform a container-based execution of a second instance of the software application using the DNS information.
14. A method of organizing distribution of information related to a domain name system, DNS, in a computer network, the computer network comprising worker nodes and an orchestrator node, each worker node being configured for container-based execution of workload distributed by the orchestrator node via the computer network, the method comprising, by a second one of the worker nodes:
   receiving DNS information from a first one of the worker nodes, the DNS information being aggregated by a container-based execution of a first instance of a software application by the first worker node; and
   performing a container-based execution of a second instance of the software application using the DNS information.
15. A computer program product for organizing distribution of information related to a domain name system, DNS, in a computer network, the computer program product comprising a computer readable storage medium having program instructions embodied therewith, the program instructions being executable by a first node of the computer network to cause the first node to perform a method comprising:
   performing a container-based execution of a first instance of a software application, thereby aggregating DNS information specific to the software application;
   generating a DNS message indicative of the DNS information; and
   transmitting the DNS message to a second node of the computer network for usage of the DNS information by a container-based execution of a second instance of the software application.
16. A computer program product for organizing distribution of information related to a domain name system, DNS, in a computer network, the computer network comprising worker nodes and an orchestrator node, the orchestrator node being configured for distributing workload via the computer network for container-based execution by the worker nodes, the computer program product comprising a computer readable storage medium having program instructions embodied therewith, the program instructions being executable by the orchestrator node to cause the orchestrator node to perform a method comprising:
   receiving a DNS message from a first one of the worker nodes, the DNS message being indicative of DNS information aggregated by a container-based execution of a first instance of a software application by the first worker node; and
   transmitting a request for a container-based execution of a second instance of the software application to a second one of the worker nodes, the request being configured to cause the second worker node to perform a container-based execution of a second instance of the software application using the DNS information.
17. A computer program product for organizing distribution of information related to a domain name system, DNS, in a computer network, the computer network comprising worker nodes and an orchestrator node, each worker node being configured for container-based execution of workload distributed by the orchestrator node via the computer network, the computer program product comprising a computer readable storage medium having program instructions embodied therewith, the program instructions being executable by a second one of the worker nodes to cause the second worker node to perform a method comprising:
   receiving DNS information from a first one of the worker nodes, the DNS information being aggregated by a container-based execution of a first instance of a software application by the first worker node; and
   performing a container-based execution of a second instance of the software application using the DNS information.
18. A computing device being configured as a first node of a computer network, the computing device comprising a processor and a memory, the memory storing program instructions which, when executed by the processor, cause the computing device to perform a method of organizing distribution of information related to a domain name system, DNS, in the computer network, the method comprising:
   performing a container-based execution of a first instance of a software application, thereby aggregating DNS information specific to the software application;
   generating a DNS message indicative of the DNS information; and
   transmitting the DNS message to a second node of the computer network for usage of the DNS information by a container-based execution of a second instance of the software application.
19. A computing device being configured as an orchestrator node of a computer network, the computer network further comprising worker nodes, the orchestrator node being configured for distributing workload via the computer network for container-based execution by the worker nodes, the computing device comprising a processor and a memory, the memory storing program instructions which, when executed by the processor, cause the computing device to perform a method of organizing distribution of information related to a domain name system, DNS, in the computer network, the method comprising:
   receiving a DNS message from a first one of the worker nodes, the DNS message being indicative of DNS information aggregated by a container-based execution of a first instance of a software application by the first worker node; and
   transmitting a request for a container-based execution of a second instance of the software application to a second one of the worker nodes, the request being configured to cause the second worker node to perform a container-based execution of a second instance of the software application using the DNS information.
20. A computing device being configured as a second worker node of a computer network, the computer network further comprising a first worker node and an orchestrator node, each worker node being configured for container-based execution of workload distributed by the orchestrator node via the computer network, the computing device comprising a processor and a memory, the memory storing program instructions which, when executed by the processor, cause the computing device to perform a method of organizing distribution of information related to a domain name system, DNS, in the computer network, the method comprising:
   receiving DNS information from the first worker node, the DNS information being aggregated by a container-based execution of a first instance of a software application by the first worker node; and
   performing a container-based execution of a second instance of the software application using the DNS information.

What is claimed is:

1. A method of organizing distribution of information related to a domain name system, DNS, in a computer network, the method comprising, by a first node of the computer network:
performing a container-based execution of a first instance of a software application, thereby aggregating DNS information specific to the software application;
generating a DNS message indicative of the DNS information; and
transmitting the DNS message to a second node of the computer network for usage of the DNS information by a container-based execution of a second instance of the software application.

2. The method of claim 1, further comprising, by the second node, transmitting a request for a container-based execution of the second instance to a third node of the computer network, the request being configured to cause the third node to perform the container-based execution of the second instance using the DNS information.

3. The method of claim 2, further comprising, by the third node, retrieving the DNS information from the first node.

4. The method of claim 2, the transmission of the DNS message being performed only if the first instance is part of a serverless workload.

5. The method of claim 2, further comprising, by the second node, storing the DNS information in a dataset of the software application within an application definition database.

6. The method of claim 1, further comprising, by the second node, performing the container-based execution of the second instance using the DNS information.

7. The method of claim 6, the transmission of the DNS message being performed only if the first instance is part of a run-to-completion workload.

8. The method of claim 1, the first node being configured for performing the aggregation of the DNS information using a first DNS cache local to the first node, the method further comprising, by the first node, initializing the container-based execution of the first instance, the initialization comprising:
requesting a recent version of the DNS information via the computer network if the first DNS cache fulfils a cold-cache criterion with respect to the software application; and
in response to receiving the recent version, filling the first DNS cache with the recent version prior to starting the container-based execution of the first instance.

9. The method of claim 1, the container-based execution of the second instance being performed by a worker node of the computer network, the method further comprising, by the worker node, filling a second DNS cache local to the worker node with the DNS information, the usage of the DNS information by the container-based execution of the second instance comprising reading the DNS information from the second DNS cache, the worker node being configured for delaying the filling of the second DNS cache until the worker node starts a container-based execution of an instance of the software application.

10. The method of claim 1, further comprising, by the first node in response to completing the execution of the first instance, deleting the DNS information if no further instance of the software application is scheduled for container-based execution by the first node.

11. The method of claim 1, the first node and the second node being registered with a common multicast group of nodes of the computer network participating in performing container-based execution of instances of the software application, the transmission of the DNS message being a multicast of the DNS message to the multicast group.

12. The method of claim 1, the DNS message indicating that the first node is available for retrieval of DNS information specific to the software application.

13. A method of organizing distribution of information related to a domain name system, DNS, in a computer network, the computer network comprising worker nodes and an orchestrator node, the orchestrator node being configured for distributing workload via the computer network for container-based execution by the worker nodes, the method comprising, by the orchestrator node:
receiving a DNS message from a first one of the worker nodes, the DNS message being indicative of DNS information aggregated by a container-based execution of a first instance of a software application by the first worker node; and
transmitting a request for a container-based execution of a second instance of the software application to a second one of the worker nodes, the request being configured to cause the second worker node to perform a container-based execution of a second instance of the software application using the DNS information.

14. A method of organizing distribution of information related to a domain name system, DNS, in a computer network, the computer network comprising worker nodes and an orchestrator node, each worker node being configured for container-based execution of workload distributed by the orchestrator node via the computer network, the method comprising, by a second one of the worker nodes:
receiving DNS information from a first one of the worker nodes, the DNS information being aggregated by a container-based execution of a first instance of a software application by the first worker node; and
performing a container-based execution of a second instance of the software application using the DNS information.

15. A computer program product for organizing distribution of information related to a domain name system, DNS, in a computer network, the computer program product comprising a computer readable storage medium having program instructions embodied therewith, the program instructions being executable by a first node of the computer network to cause the first node to perform a method comprising:
performing a container-based execution of a first instance of a software application, thereby aggregating DNS information specific to the software application;
generating a DNS message indicative of the DNS information; and
transmitting the DNS message to a second node of the computer network for usage of the DNS information by a container-based execution of a second instance of the software application.

16. A computer program product for organizing distribution of information related to a domain name system, DNS, in a computer network, the computer network comprising worker nodes and an orchestrator node, the orchestrator node being configured for distributing workload via the computer network for container-based execution by the worker nodes, the computer program product comprising a computer readable storage medium having program instructions embodied therewith, the program instructions being executable by the orchestrator node to cause the orchestrator node to perform a method comprising:
receiving a DNS message from a first one of the worker nodes, the DNS message being indicative of DNS information aggregated by a container-based execution of a first instance of a software application by the first worker node; and
transmitting a request for a container-based execution of a second instance of the software application to a second one of the worker nodes, the request being configured to cause the second worker node to perform a container-based execution of a second instance of the software application using the DNS information.

17. A computer program product for organizing distribution of information related to a domain name system, DNS, in a computer network, the computer network comprising worker nodes and an orchestrator node, each worker node being configured for container-based execution of workload distributed by the orchestrator node via the computer network, the computer program product comprising a computer readable storage medium having program instructions embodied therewith, the program instructions being executable by a second one of the worker nodes to cause the second worker node to perform a method comprising:
receiving DNS information from a first one of the worker nodes, the DNS information being aggregated by a container-based execution of a first instance of a software application by the first worker node; and
performing a container-based execution of a second instance of the software application using the DNS information.

18. A computing device being configured as a first node of a computer network, the computing device comprising a processor and a memory, the memory storing program instructions which, when executed by the processor, cause the computing device to perform a method of organizing distribution of information related to a domain name system, DNS, in the computer network, the method comprising:
performing a container-based execution of a first instance of a software application, thereby aggregating DNS information specific to the software application;
generating a DNS message indicative of the DNS information; and
transmitting the DNS message to a second node of the computer network for usage of the DNS information by a container-based execution of a second instance of the software application.

19. A computing device being configured as an orchestrator node of a computer network, the computer network further comprising worker nodes, the orchestrator node being configured for distributing workload via the computer network for container-based execution by the worker nodes, the computing device comprising a processor and a memory, the memory storing program instructions which, when executed by the processor, cause the computing device to perform a method of organizing distribution of information related to a domain name system, DNS, in the computer network, the method comprising:
receiving a DNS message from a first one of the worker nodes, the DNS message being indicative of DNS information aggregated by a container-based execution of a first instance of a software application by the first worker node; and
transmitting a request for a container-based execution of a second instance of the software application to a second one of the worker nodes, the request being configured to cause the second worker node to perform a container-based execution of a second instance of the software application using the DNS information.

20. A computing device being configured as a second worker node of a computer network, the computer network further comprising a first worker node and an orchestrator node, each worker node being configured for container-based execution of workload distributed by the orchestrator node via the computer network, the computing device comprising a processor and a memory, the memory storing program instructions which, when executed by the processor, cause the computing device to perform a method of organizing distribution of information related to a domain name system, DNS, in the computer network, the method comprising:
receiving DNS information from the first worker node, the DNS information being aggregated by a container-based execution of a first instance of a software application by the first worker node; and
performing a container-based execution of a second instance of the software application using the DNS information.
